(19) United States
(12) Patent Application Publication
(10) Pub. No.: US 2008/0060915 A1
(43) Pub. Date: Mar. 13, 2008

(54) Article conveyor, in particular for airline baggage

(76) Inventor: Michael Kuhn, Sinsheim (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/899,101

(22) Filed: Sep. 4, 2007

(30) Foreign Application Priority Data
Sep. 8, 2006 (DE) 10 2006 042 179.5

(51) Int. Cl. B65G 17/12

(52) U.S. Cl. 198/717

(57) ABSTRACT

The invention relates to an article conveyor, in particular for airline baggage, comprising a kind of rail track with individual carriers which are connected to one another and, for receiving an article in each case, are provided with a transverse conveyor by means of which the articles resting on the carrier can be moved, in a motor-driven manner, transversely to the transporting direction of the article conveyor. In order to prevent articles from being thrown off accidentally during transportation, in particular over curved sections, it is proposed that the transverse conveyor comprises a chain belt which is flexible in the direction of circulation, is flexurally rigid in the longitudinal direction of the article conveyor and comprises chain-belt links which are connected to one another in an articulated manner on the longitudinal sides of the chain belt and are in the form of strips or narrow plates.

### CROSS REFERENCE TO RELATED APPLICATIONS

This application claims the benefits of German application No. 10 2006 042 179.5 filed Sep. 8, 2006 and is incorporated by reference herein in its entirety.

### FIELD OF INVENTION

The invention relates to an article conveyor, in particular for airline baggage, having a guide frame for a load-bearing arrangement which is borne by this guide frame, is driven in the longitudinal direction of the guide frame and comprises a multiplicity of carriers which are connected to one another to form a kind of rail track and, for receiving at least one article in each case, are provided with a driven transverse conveyor which is guided endlessly about deflecting rollers, mounted on both sides of the carrier, and by means of which the articles resting on the carrier can be moved, in a motor-driven manner, transversely to the transporting direction of the article conveyor.

### BACKGROUND OF THE INVENTION

Driven vehicle frames on which a tray is carried along are known for the purpose of transporting articles, in particular airline baggage. Trays have the advantage that any kind of article or baggage can be reliably transported therein, because it is often the case, particularly with airline baggage, that the articles are non-rigid ones, such as rucksacks, bags, etc., which are very difficult to convey on smooth belt conveyors. In contrast, even articles which are capable of rolling can be transported in the trays. The disadvantage here is that, for the purpose of unloading the trays, they have to be separated from the vehicles carrying them, in order for it to be possible for the released tray to be emptied using a tilting mechanism. A comparatively expensive and complex mechanism, a number of which often have to be provided within the conveying installation, is necessary for this purpose. It is also the case that the trays are subjected to very pronounced mechanical loading and, as a result of the considerable wear, have to be changed frequently. This gives rise to a not inconsiderable cost factor within an airline-baggage conveying installation.

For the purpose of transporting articles, it is likewise known to use so-called crossbelt conveyors in which the known rigid tray is replaced by a transverse conveyor which, for its part, is arranged on a vehicle frame serving as carrier. The transverse conveyor is driven in an endless manner, the drive likewise being provided on the vehicle frame. The transverse conveyor is oriented at right angles to the transporting direction of the actual article conveyor, which comprises a multiplicity of carriers which are connected to one another in the manner of a rail track and each have a respective transverse conveyor. The article rests on the transverse conveyor, which is initially at a standstill, and is advanced in the longitudinal direction of a guide frame as the interconnected carriers are transported. The carriers themselves may be provided with running-gear mechanisms which roll on rail tracks of the guide frame. At the unloading location, the respective transverse conveyor which is to be unloaded is driven in its direction of circulation, as a result of which the article resting on it is removed laterally from the carrier.

Such conveyors, or crossbelt conveyors, are very well-suited for sorting articles, but have the disadvantage that they may have difficulties in transporting articles which are capable of rolling or are non-rigid if articles are thrown off laterally from the conveyor over curved sections as a result of the active centrifugal forces. A conveyor of the type described has been disclosed, for example, in U.S. Pat. No. 3,231,068; here, the crossbelt is indeed provided with stud-like elevations, but these cannot prevent articles which are capable of rolling and tilting from resting in an unstable manner on the crossbelt and being able to fall off the same.

Taking a conveyor of the type described in the introduction as a departure point, the object of the present invention is to ensure that the article resting on the conveyor, regardless of its three-dimensional shape, can be transported reliably even over curved sections, and that effective and reliable unloading of the article from the crossbelt can take place in the unloading region of the article conveyor.

### SUMMARY OF INVENTION

In order to achieve this object, the article conveyor of the generic type is improved in that the transverse conveyor comprises a chain belt which is flexible in its direction of circulation, is flexurally rigid in the longitudinal direction of the article conveyor and comprises chain links which are connected to one another in an articulated manner on the longitudinal sides of the chain belt and are in the form of strips or narrow plates. The known endless belt of a crossbelt conveyor is thus replaced by a chain belt which is formed in the manner of a plate conveyor and, as a result of it being designed in a flexurally rigid manner in the longitudinal direction of the article conveyor, ensures that any kind of article can rest reliably on it and, at the same time, allows the chain belt to be deflected in a flexible manner about the deflecting rollers provided on both sides of the carrier.

It is particularly advantageous if such a transverse conveyor is guided about the deflecting rollers such that a concave bearing surface for an article is formed, between the deflecting rollers, on the side of the top strand. It is thus possible, by utilizing its own weight, for the top side of the transverse conveyor to sag, thus forming a trough between the deflecting rollers which prevents the article from falling laterally from the conveyor. For this purpose, the circulating chain belt is guided without tensioning between the deflecting rollers.

As an alternative, according to another feature of the invention, it is also possible for the concave bearing surface for the article to be the inevitable result of form-fitting guides on both sides of the outer chain-belt links. In this way, the bearing surface or trough can be established from the outset and can thus form a reliable “transporting tray” in the transverse conveying belt.

In order to ensure that the article can be thrown off laterally at the unloading location of the article conveyor by virtue of the crossbelt being driven transversely, a particularly advantageous feature of the invention provides that individual links of the chain belt can be set in an upright position in order to form a carry-along element in the region of the top strand as the chain belt circulates. With the chain belt sagging or being guided in a correspondingly tensioning-free manner, it is possible to force the articulations to move upward in the region between two adjacent links of the chain belt, in which case the adjacent links move upward in a roof-like manner about their respectively outer articulation. This produces an elevation on the otherwise smooth bearing surface of the transverse conveyor, and this elevation can serve as a carry-along element as an article is transported away.

The individual links of the chain belts are set in an upright position in the region of the top strand by actuators which act from beneath, in the envisaged region, on the links which are to be set in an upright position, and set in each case two adjacent links in an upright position in order to form the roof-like carry-along element. The actuators here circulate with the chain belt and are actuated via fixed abutments, provided on the carrier, when the corresponding region of the chain belt runs over the abutment. Such a chain belt is disclosed, for example, in Dutch Patent 102 10 84. The transporting belt described in this document can be used very advantageously in modified form for the article-conveying installations in question which are found in airports. A mechanism which can be used for setting adjacent links of the chain belt in an upright position, and the actuators provided for this purpose, can be gathered from this patent; reference is made thereto. Of course, other forms of actuator which have the same or a similar effect are also conceivable.

If, according to a special feature of the invention, in each case two carry-along elements which are set in an upright position at a distance from one another on the chain belt form a lateral means which safeguards against articles falling off during transportation, it is possible, if appropriate, to dispense with the troughed formation of the chain belt. As the article conveyor is transported in the longitudinal direction, the carry-along elements are set in an upright position on both sides of the article-bearing surface, the chain belt and/or the actuators being positioned correspondingly in relation to the abutments. For unloading purposes, i.e. when the chain belt is moved transversely, the actuator which is assigned to the unloading side runs around the deflecting roller and moves down out of the transporting plane of the transverse conveyor. The piece of baggage, should it slip on the surface, is carried along reliably, and transported to the unloading side, by the carry-along element formed on the opposite side by the corresponding chain links set in an upright position.

In addition, or as an alternative, the bearing surfaces of the individual links of the chain belt may be formed from a non-slip material or have a non-slip coating.

### BRIEF DESCRIPTION OF THE DRAWINGS

An exemplary embodiment of the present invention is described hereinbelow and illustrated in the drawing, in which:

FIG. 1 shows a cross section through the carrier of an article conveyor of the invention, in a roughly schematic illustration, with a troughed transverse conveyor,

FIG. 2 shows another embodiment of the carrier with carry-along elements set in an upright position as a transportation safeguard on both sides of the article which is to be transported, and

FIG. 3 shows the functional principle of an actuator in the form of an isosceles triangle.

### DETAILED DESCRIPTION OF INVENTION

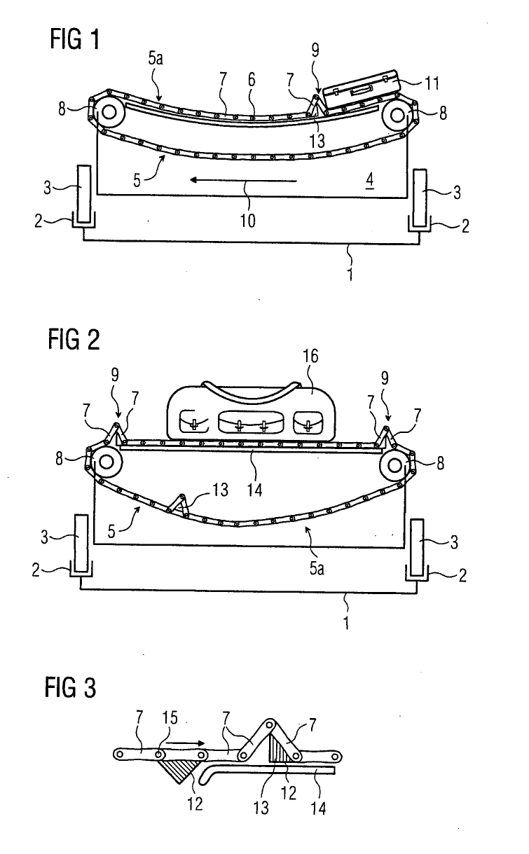

FIG. 1 shows, in a roughly schematic illustration, a cross section through a carrier 4 of the load-bearing arrangement, the article conveyor being formed by a multiplicity of carriers 4 which are connected to one another to form a kind of rail track. In FIG. 1, the guide frame is designated by 1. It bears the two sections 2 of rail, on which the carriers 4 roll on wheels 3. The sections of rail are laid in an endless loop; branching locations and intersections are possible in the case of rail tracks. The carriers 4 are coupled to one another in a known manner and form either a train or a continuous conveyor system. The transverse conveyor according to the invention, which is designated by 5, is arranged on the carrier 4. The transverse conveyor 5 forms a chain belt 5a which is flexurally rigid in the transporting direction of the carriers 4 of the article conveyor (perpendicularly to the plane of the drawing) and comprises chain-belt links 7 which are connected to one another in an articulated manner at 6, each chain-belt link 7 being in the form of a strip or narrow elongate plate with a length corresponding approximately to the length of the carrier 4.

As can be seen in FIG. 1, the chain belt 5a is guided about the deflecting rollers 8, which are mounted in a rotatable manner on both sides of the carrier 4. Preferably at least one of the deflecting rollers can be driven directly or indirectly (not illustrated). The fact that the chain belt 5a is flexible in the direction transverse to the transporting direction of the article conveyor makes deflection about the deflecting rollers 8 possible, the radius of deflection being dependent on the width of the strip or of the narrow plates of the chain-belt links 7.

In FIG. 1, as can be seen at 9, a carry-along element has been formed by two adjacent chain-belt links 7 having been upwardly set in an upright position in the form of a roof. As the transverse conveyor circulates in arrow direction 10, the resulting carry-along element carries along the suitcase 11 illustrated here to the right (as seen in the drawing). The chain-belt link 7 are set in an upright position via an actuator 13, which is yet to be described with reference to FIGS. 2 and 3.

As can be seen in FIG. 1, the chain belt 5a of the transverse conveyor 5 is guided in a trough-like manner between the deflecting rollers 8, this forming a kind of tray for receiving the item of baggage, and this prevents the suitcase 11 from being thrown off laterally from the conveyor, for example over a curved section. This trough-like or concave depression can be formed by means of the chain belt 5a sagging; however, it is also possible for the end sides of the chain-belt links 7 to be guided in a form-fitting manner in guides on both sides, in order thus to form the concave profile.

FIG. 2 illustrates a solution in which the chain belt 5a is essentially horizontally guided and deflected about the deflecting rollers 8. Along the lower strand, the chain belt 5a sags and assumes the length which is required in order for individual chain-belt links 7 selected to be set in an upright position as carry-along elements 9. As can be seen in FIG. 2, a non-rigid item of baggage (article 16), e.g. a holdall, rests on the chain belt 5a of a carrier 4 during operation and transportation of the article conveyor. The carry-along elements 9 have been set in an upright position on both sides of the item of baggage, and are formed by in each case two adjacent links 7 of the chain belt 5a having been set in an upright position in a roof-like manner in the region of the deflecting rollers 8. The carry-along elements 9, which are fixed in this position when the transverse conveyor 5 is at a standstill, provide a barrier against the item of baggage falling downwards, and this barrier is maintained as the article conveyor is transported longitudinally. It is only at the envisaged unloading location, that is to say where the transverse conveyor 5 moves to the right or left (as seen in the plane of the drawing) that the carry-along elements 9 on the unloading side are removed, by virtue of the actuators 13 moving downward, and the carry-along element 9 which is set in upright position opposite the unloading side causes the article 13 to leave the transverse conveyor 5.

The actuators 13 are in a form of an isosceles triangle of which the two corners are connected to the articulations of a chain-belt link 7. The bearing surface on the underside of the top strand of the chain belt 5a serves at the same time, as an abutment 14 for the actuators 13. As soon as the chain belt 5a, with the actuator 13 articulated in a manner described, has passed the deflecting roller 8, one side surface 12 of the triangle positions itself against the abutment 14, in which case the triangle is pivoted upward about the leading point of articulation (15 in FIG. 3), as a result of which the link 7 and the adjacent link 7 of the chain belt 5a are forced upward. This operation is illustrated schematically in FIG. 3.

As soon as the corresponding links 7 of the chain belt 5a leave the abutment 14 as the transverse conveyor is transported further, the triangle pivots downward and the carry-along element 9 which is formed beforehand disappears as a result of the chain-belt links 7 straightening out. Suitable positioning of the actuators 13 on the chain belt 5a and/or corresponding positioning of the abutment 14 make it possible for carry-along elements 9 to be formed, and removed again, at any desired locations of the chain belt 5a. The carry-along elements 9 result in reliable unloading of the chain belt 5a at the unloading location of the article conveyor even in the case of articles which are difficult to handle.

In addition too, or instead of, the carry-along elements 9, the top sides of the chain-belt links 7 may be provided with a non-slip coating or may themselves be of non-slip design.

1.-9. (canceled)

10. An article conveyor for airline baggage, comprising:
a plurality of carriers connected to form a rail track where each carrier is configured to receive an article;
a guide frame that supports the plurality of carriers where the carriers are driven in a longitudinal direction of the guide frame; and
a driven transverse conveyor that is guided endlessly about deflecting rollers mounted on both sides of the carrier, where the articles resting on the carrier are moved via a motor, transversely to the transporting direction of the article conveyor, wherein the transverse conveyor comprises a chain belt flexible in a direction of circulation that is flexurally rigid in a longitudinal direction of the article conveyor and comprises chain-belt links which are connected to one another in an articulated manner on the longitudinal sides of the chain belt and are in the form of strips or narrow plates.

11. The article conveyor as claimed in claim 10, wherein a concave bearing surface for an article is formed between the deflecting rollers on a side of the top strand of the chain belt.

12. The article conveyor as claimed in claim 11, wherein the concave bearing surface for the article is formed by sagging of the chain belt circulating without tensioning between the deflecting rollers.

13. The article conveyor as claimed in claim 11, wherein the concave bearing surface for the article is the inevitable result of form-fitting guides on both sides of the outer chain-belt links.

14. The article conveyor as claimed in claim 10, wherein individual links of the chain belt are set in an upright position in order to form a carry-along element in a region of the top strand as the chain belt circulates.

15. The article conveyor as claimed in claim 14, wherein individual links of the chain belt are set in an upright position in the region of the top strand by actuators which circulate with the chain belt act from beneath, in envisaged regions, on the chain-belt links that are set in an upright position, and erect in each case two adjacent chain-belt links in order to form a roof-like carry-along element.

16. The article conveyor as claimed in claim 15, wherein two carry-along elements set in an upright position at a distance from one another on the chain belt forms on both sides a safeguard against articles falling off the conveyor.

17. The article conveyor as claimed in claim 15, wherein the actuators can be actuated by fixed abutments provided on the carrier as the chain belt circulates.

18. The article conveyor as claimed in claim 15, wherein the bearing surfaces of the individual links of the chain belt have a non-slip surface.

19. The article conveyor as claimed in claim 18, wherein the bearing surfaces of the individual links of the chain belt consist of a non-slip material or have a non-slip coating.
